(19) United States
(12) Patent Application Publication
(10) Pub. No.: US 2013/0009864 A1
(43) Pub. Date: Jan. 10, 2013

(54) METHOD AND APPARATUS FOR INTERFACING BETWEEN EXTERNAL DEVICE AND MOBILE DEVICE

(75) Inventor: Hyun Seok JEONG, Bucheon-si (KR)

(73) Assignee: SAMSUNG ELECTRONICS CO. LTD., Suwon-si (KR)

(21) Appl. No.: 13/540,786

(22) Filed: Jul. 3, 2012

(30) Foreign Application Priority Data
Jul. 8, 2011 (KR) 10-2011-0067824

(51) Int. Cl. G06F 3/01

(52) U.S. Cl. 345/156

(57) ABSTRACT

An apparatus for interfacing between a mobile device and an external device is provided. The apparatus includes a mobile device which includes image data for the external device, and which transmits to the external device an image signal corresponding to the image data according to a selection, and an external device which displays the image data corresponding to the image signal received from the mobile device, which generates an input signal according to a user's input, and which transmits the generated input signal to the mobile device, wherein the image signal of the mobile device and the input signal of the external device are transmitted and received through a single interface used for a connection between the mobile device and the external device.

### PRIORITY

This application claims the benefit under 35 U.S.C. §119(a) of a Korean patent application filed on Jul. 8, 2011 in the Korean Intellectual Property Office and assigned Serial No. 10-2011-0067824, the entire disclosure of which is hereby incorporated by reference.

### BACKGROUND OF THE INVENTION

1. Field of the Invention

The present invention relates to a method and apparatus for interfacing between an external device and a mobile device. More particularly, the present invention relates to a method and apparatus for constituting an interface between a mobile device and external accessories which are connected to the mobile device and support the input and output of the mobile device.

2. Description of the Related Art

Recently, with the advancement of digital technologies, various mobile devices, which enable communication and personal information processing while moving, are being introduced. Examples of the mobile devices include a Personal Digital Assistant (PDA), an electronic notebook, a smart phone, and a tablet Personal Computer (PC), etc.

Such mobile devices now have various functions, such as a video call function, an electronic note function, a document function, an e-mail function, an Internet function, etc., as well as a basic voice call function and a text messaging function.

Such mobile devices are continually evolving with the advancements of technologies and to the changes in user's needs. Further, with the evolution of the mobile devices, various accessories for the convenience of users of the mobile devices are also being developed.

In particular, there is a limitation in the size of mobile devices, and thus the input and output devices of mobile devices are formed in a small size. Therefore, when a user views an image (e.g., a moving picture or a still image), or performs an input for controlling the image or an input of preset data using the mobile device while viewing an image, the user may be inconvenienced. In order to address this problem, various external devices (e.g., an external accessory including a display device and an integral or separate input device), which can support input and output functions of a mobile device, are recently being introduced. That is, a recent mobile device has implemented functions similar as those of a personal computer, and input and output accessories have been provided to efficiently use such functions.

Further, various ideas for constitution of an interface for connection between an external device and a mobile device are being suggested. For example, an external device and a mobile device can be interconnected by a High Definition Multimedia Interface (HDMI) port for outputting a High-Definition (HD) image (e.g., HD video) provided from the mobile device using a display device of the external device, and a Universal Serial Bus (USB) port for transmitting and receiving data input by an input device (e.g., a keyboard and a mouse, etc.) of the external device.

Likewise, the interface between the external device of the related art and the mobile device utilizes at least two connectors including a first port (e.g., a HDMI port) for connecting the display device of the external device with the mobile device, and a second port (e.g., a USB port) for connecting the input device of the external device with the mobile device.

Hence, when using an external device for the sake of convenience in using an input and output function of a mobile device, the user should inconveniently connect at least two connectors in order to connect the mobile device to the external device. Further, because at least two connectors need to be used, when designing a mobile device and an external device, additional considerations for installation space, height and size, etc., are required. Further, because the user needs to connect at least two connectors respectively to connection ports (at least four connection ports in total) included in the external device and the mobile device, the possibility of malfunction of the device increases when connecting devices. Further, when the user carries a mobile device, the user should inconveniently also carry two connectors.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for interfacing between a mobile device and an external device that supports an input and output of the mobile device.

Another aspect of the present invention is to provide an interface method and apparatus which can support the external input and output functions of a mobile device by a connection using a single connector between an external device and the mobile device.

Another aspect of the present invention is to provide a method and apparatus for interfacing between an external device and a mobile device so as to display an image from the mobile device using a display device of the external device and to enable control according to an input from an input device of the external device, simultaneously, by using a single connector.

Another aspect of the present invention is to provide a method and apparatus for interfacing between an external device and a mobile device so as to improve user convenience and improve usability and competitiveness of the external device and the mobile device by implementing an optimal environment for the use of a mobile device using an input and display device of the external device.

In accordance with an aspect of the present invention, a method of interfacing between a mobile device and an external device is provided. The method includes detecting an event generated in a state where the external device is connected to the mobile device through a single interface based on a Mobile High definition Link (MHL) technology, if the detected event is an output event of the external device, performing a first display process by converting an image signal transmitted from the mobile device and displaying the converted image signal using a display device, if the detected event is an input event of the external device, converting an input signal generated by an input device and transmitting the converted input signal to the mobile device through the single interface, and if a response signal based on the input signal is received from the mobile device, performing a second display process by converting the response signal from the mobile device and displaying the converted response signal using the display device.

In accordance with another aspect of the present invention, an apparatus for interfacing between a mobile device and an external device is provided. The apparatus includes a mobile device which includes image data for the external device, and which transmits to the external device an image signal corresponding to the image data according to a selection, and an external device which displays the image data corresponding to the image signal received from the mobile device, which generates an input signal according to a user's input, and which transmits the generated input signal to the mobile device, wherein the image signal of the mobile device and the input signal of the external device are transmitted and received through a single interface used for a connection between the mobile device and the external device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 schematically illustrates a configuration of an interface for connecting an external device to a mobile device according to an exemplary embodiment of the present invention;

FIG. 2 schematically illustrates a configuration of an external device according to an exemplary embodiment of the present invention;

FIG. 3 illustrates an image signal transmission and reception relationship between an external device and a mobile device according to an exemplary embodiment of the present invention;

FIG. 4 illustrates an input signal transmission and reception relationship between an external device and a mobile device according to an exemplary embodiment of the present invention; and

FIG. 5 is a flowchart illustrating a method of processing a signal according to a connection between an external device and a mobile device.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a method and apparatus for interfacing between an external device and a mobile device, and more particularly, to a method and apparatus for interfacing accessories, which externally support an input and output function of a mobile device, and the mobile device using a single connector. According to an exemplary embodiment of the present invention, when a mobile device is connected to an external device that is used as an accessory for the input and output of the mobile device, an interface for inputting and outputting data of each device can be formed as a single interface. In particular, according to an exemplary embodiment of the present invention, each device is connected through a Mobile High definition Link (MHL) based interface, and the configuration of a single interface can be implemented by transmitting a signal generated by an input device of the external device using the MHL-based interface which can output the image of the mobile device using a display device of the external device. Hence, according to an exemplary embodiment of the present invention, the configuration of an additional interface for connection between the input device of an external device and a mobile device can be omitted. According to an exemplary embodiment of the present invention, it is possible to use a CBUS line in a MHL-based interface for transmission of an input signal of an external device to a mobile device.

Hereinafter, a configuration of an interface between an external device and a mobile device and a method of controlling operation of the interface will be described with reference to the drawings. However, the configuration of an interface and the method for controlling the interface according to an exemplary embodiment of the present invention are not limited to the explanation described below, and can be applied to various other embodiments based on the exemplary embodiments explained below.

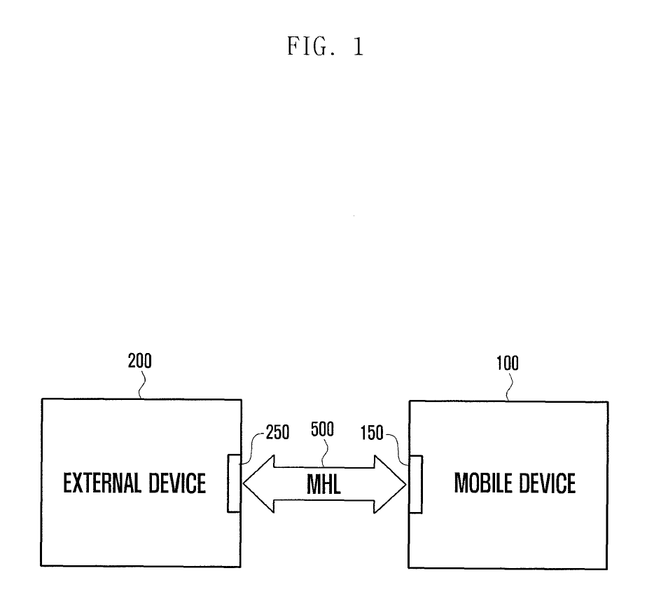

FIG. 1 schematically illustrates a configuration of an interface for connecting an external device to a mobile device according to an exemplary embodiment of the present invention.

Referring to FIG. 1, a system of an exemplary embodiment of the present invention is divided into a mobile device 100 and an external device 200, and includes an interface 500 for connecting the mobile device 100 to the external device 200.

In the present exemplary embodiment, the mobile device 100 may be any of an information communication device, a multimedia device, an application device, etc., which can be connected to the external device through the interface 500. For example, the mobile device can include a tablet Personal Computer (PC), a smart phone, a Portable Multimedia Player (PMP), a digital broadcast player, a Personal Digital Assistant (PDA), a portable game terminal, and a digital camera, etc., as well as a mobile communication terminal operated under communication protocols corresponding to various communication systems.

In particular, in the present exemplary embodiment, the mobile device 100 includes image data for the external output, and can transmit image signals of the image data according to the user's selection to the external device 200. Further, the mobile device 100 can perform internal processing according to an input signal transmitted from the external device 200, and transmit a response signal according to the internal processing to the external device 200. At this time, the image signal transmission, the input signal reception and the response signal transmission can be performed through the interface 500.

In an exemplary the present exemplary embodiment, the external device 200 is a device comprising a display device such as a television, a Large Format Display (LFD) and a monitor, and an input device externally connected to the display device through an interface of a certain standard, or a device where a display device and an input device are internally connected through an interface of a certain standard. In particular, in an exemplary embodiment of the present invention, the external device 200 is any type of device which is connected to the mobile device 100 through the interface 500, and can substitute the input and output of the mobile device 100. The interface of the certain standard for connection between the display device and the input device may include an interface using a communication method such as a Universal Serial Bus (USB), a Universal Asynchronous Receiver/Transmitter (UART), a Serial Peripheral Interface (SPI), and a Pulse Width Modulation (PWM), etc. Further, the input device can include a keyboard, a mouse and a touchpad, etc.

In particular, in the present exemplary embodiment, the external device can output an image according to an image signal transmitted through the interface 500 using the display device, transmit an input signal generated by the input device to the mobile device 100 through the interface 500, and receive a response signal corresponding to the input signal through the interface 500 and output the image according thereto using the display device.

In the present exemplary embodiment, the interface 500 for connection between the mobile device 100 and the external device can be configured based on a micro USB connector, and a representative example of such an interface is an interface that supports MHL technology. In the present exemplary embodiment, the MHL technology can be a communication method for transmitting an image (e.g., an HD image) signal provided in the mobile device 100 to the external device 200, and transmitting the input signal generated in the external device 200 to the mobile device 100.

That is, according to the present exemplary embodiment, the mobile device 100 and the external device 200 can be connected by the interface 500 operated by a single connector, and the input and the output between the mobile device 100 and the external device 200 can be simultaneously supported. Here, according to the related art, a display device and an input device are connected respectively using two different connectors, and the signal transmission and reception between the connected units are separately operated as in connecting the mobile device 100 to the display device for the external output of an image signal generated in the mobile device 100 through a first interface (e.g., an HDMI port), and connecting the mobile device 100 to the input device for generation of an input signal, such as a function control of the mobile device 100, through a second interface (e.g., a USB port).

Further, according to an exemplary embodiment of the present invention, as explained above, a mobile device 100 and an external device 200 are connected through a single interface 500 based on a micro USB connector (e.g., a MHL). Further, the interface 500 can include a Voltage Bus (VBUS) signal line (and possibly a ground (GND) line), a Communication Bus (CBUS) signal line, and a Transition Minimized Differential Signaling (TMDS) line. Therefore, the mobile device 100 and the external device 200 can include connectors 150 and 250 which include a VBUS signal line, a CBUS signal line and a TMDS line, respectively.

In the exemplary embodiment of the present invention, image signals of the mobile device 100 are transmitted to the external device 200 respectively through the TMDS line, the charging of the mobile device 100 is supported by using the power supplied to the external device 200 through the VBUS signal line, and the input signals of the external device 200 can be transmitted to the mobile device 100 respectively through the CBUS signal line. Further, the change in the status according to the connection and disconnection between the mobile device 100 and the external device 200 through the CBUS signal line can be determined.

In particular, according to an exemplary embodiment of the present invention, an input signal generated in the external device 200 can be transmitted to the mobile device 100 using the CBUS signal line of the interface 500 as described above. Then the mobile device 100 can receive an input signal through the CBUS signal line of the interface 500 and perform the internal processing according thereto, and transmit a response signal (e.g., an image signal which reflects the result of the internal processing) corresponding to the input signal to the external device 200 through the TMDS signal line. The external device 200 can receive a response signal corresponding to the input signal through the TMDS signal line of the interface 500, and display the received response signal using the display device.

That is, according to an exemplary embodiment of the present invention, a signal interface for connection between a mobile device 100 and an external device 200 which supports the input and output functions can be implemented by transmitting an input signal generated in the external device 200 (especially, the input device of the external device 200) using the CBUS signal line of the interface. As such, connectors (e.g., a USB, etc.) for transmission of other signals other than the interface 500 (i.e., the micro USB connector (MHL)) can be omitted.

Hereinafter, the configuration of an external device 200 for supporting the external input and external output of a mobile device 100 based on a single connector, and the signal processing operation by the external device 200 will be described.

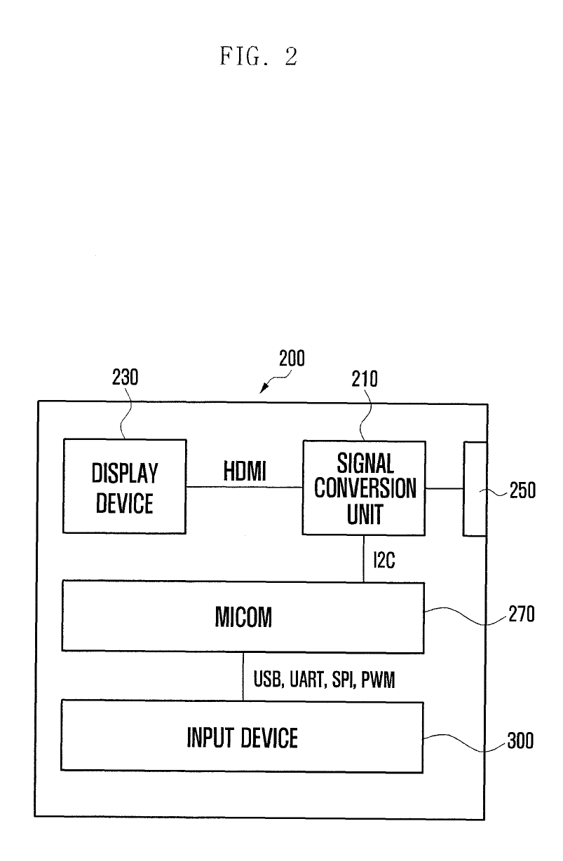

FIG. 2 schematically illustrates a configuration of an external device according to an exemplary embodiment of the present invention.

Referring to FIG. 2, the external device 200 of an exemplary embodiment of the present invention includes a connector 250, a signal conversion unit 210, a display device 230, a Micro Computer (MICOM) 270, and an input device 300. Further, the external device 200 of the present exemplary embodiment may further include other components, such as an output device like a speaker, a storage device for storing data, and a battery or external power supply unit for supplying power. However, an explanation and illustration of other components are omitted herein for brevity.

The connector 250 supports connection with the mobile device 100 through the interface 500. As explained above, the connector 250 can include a VBUS signal line, a CBUS signal line and a TMDS line in order to support a connection corresponding to the line configuration of the interface 500.

When an image signal provided in the mobile device 100 is transmitted through the interface 500, the signal conversion unit 210 converts the image signal into a signal that can be outputted through a display device 230. In particular, the signal conversion unit 210 can convert a MHL image signal into a HDMI image signal. For example, the image signal generated in the mobile device 100 is converted into an MHL image signal for transmission through the interface 500 based on the MHL technology, and the converted MHL image signal is transmitted to the signal conversion unit 210 through the TMDS line of the connector 250 connected to the interface 500. Then the signal conversion unit 210 can convert the transmitted MHL image signal into the HDMI image signal so that the MHL image signal can be outputted by the display device 230. Further, the signal conversion unit 210 can convert an Inter-Integrated Circuit (IC) (I2C) type input signal transmitted from the MICOM 270 into an MHL input signal for transmission through the interface 500 based on the MHL technology, and the converted MHL input signal can be transmitted to the CBUS line of the connector 250. Then the MHL input signal inputted to the CBUS line of the connector 250 is transmitted to the mobile device 100.

The display device 230 can display the operation status of the external device 200 and an image related with the operation of the device 200. In particular, the display device 230 can display an image corresponding to the HDMI image signal which was transmitted from the mobile device and was then converted using the signal conversion unit 210. A Liquid Crystal Display (LCD) is generally used as the display device 230, but other devices such as a Light Emitting Diode (LED), an Organic LED (OLED), and an Active Matrix OLED (AMOLED), etc., can also be used. Further, in the present exemplary embodiment, the display device 230 can be separated from the input device 300 and can be independently configured. For example, a monitor, a TeleVision (TV), and a Large Format Display (LFD), etc., can be used.

The MICOM controls overall operation of the external device. In particular, in the present exemplary embodiment, the MICOM 270 receives an input signal generated in an input device 300 internally or externally connected through a certain interface (e.g., a USB, a UART, a SPI, and a PWM, etc.), and converts the received input signal into a signal to be transmitted to the mobile device 100. That is, the MICOM supports communication between an input device 300 and a mobile device 100, and converts a user command (an input signal) transmitted from the input device 300 into a preset signal and transmits the converted signal to the mobile device 100. For example, if a preset input signal is transmitted from an internally or externally connected input device 300, the MICOM 270 converts the input signal into a I2C-type signal and transmits the converted signal to the signal conversion unit 210. At this time, if the converted I2C signal is transmitted to the signal conversion unit 210, the signal conversion unit 210 can convert the I2C signal into an MHL signal to be transmitted through the CBUS line. Thereafter, the converted MHL signal is transmitted to the mobile device 100 through the CBUS line.

The input device 300 controls the function of the mobile device 100 connected through the interface 500 and allows an input of data. When a user input using the input device 300 occurs, a corresponding input signal is generated, and is then transmitted to the mobile device 100 through the interface 500. The input device 300 can comprise at least one of a touch pad that supports a touch-based input, a keyboard that supports a physical key input, and a mouse that supports a pointing-based input, etc. In the present exemplary embodiment, the input device 300 can be integrally provided by being included in the external device 200, or can be provided as an independent unit which is separated from the external device 200. The input device 300 can be connected to the MICOM 270 through an interface according to one of the communication methods such as a USB, UART, SPI and PWM, etc.

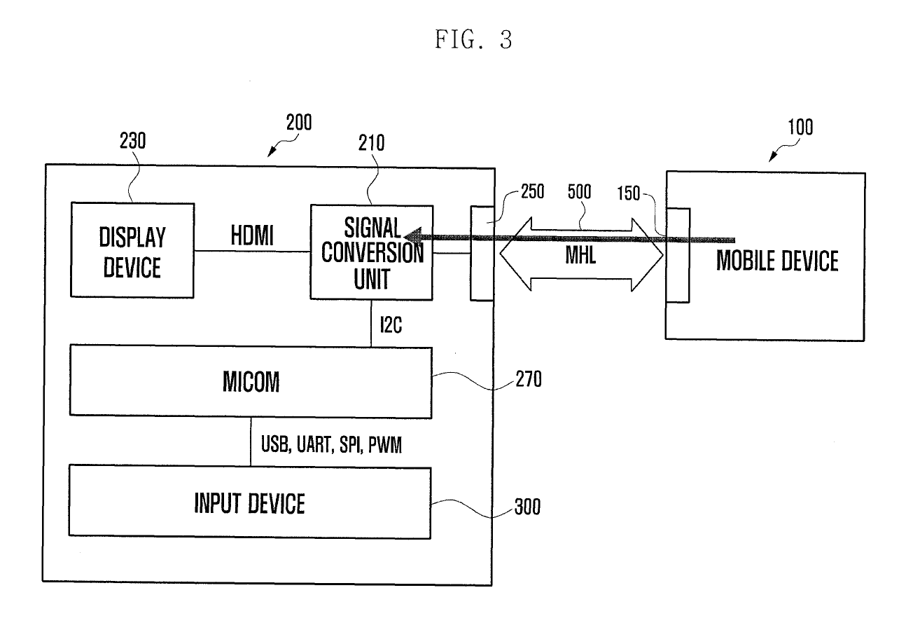

FIG. 3 illustrates an image signal transmission and reception relationship between an external device and a mobile device according to an exemplary embodiment of the present invention.

Referring to FIG. 3, it is assumed that the mobile device 100 is connected to the external device 200 through the interface 500 based on the MHL technology. Further, image data according a user's selection (e.g., HD level moving picture data) can be replayed in the mobile device 100. Thereafter, an image signal for the image data of the mobile device 100 can be transmitted to the external device 200 through the interface 500. In particular, the image signal of the mobile device 100 can be transmitted through the TMDS line of the interface 500.

Further, the external device 200 is connected to the mobile device 100, and if the image signal is transmitted through the interface 500, the MHL-based image signal can be converted into an image signal based on HDMI. That is, the external device 200 can receive an image signal based on the MHL through the TMDS line of the connector 250. Further, the external device 200 converts the MHL-based image signal received through the TMDS line of the connector 250 into a HDMI-based image signal through the signal conversion unit 210, and outputs the converted image signal through the display device 230.

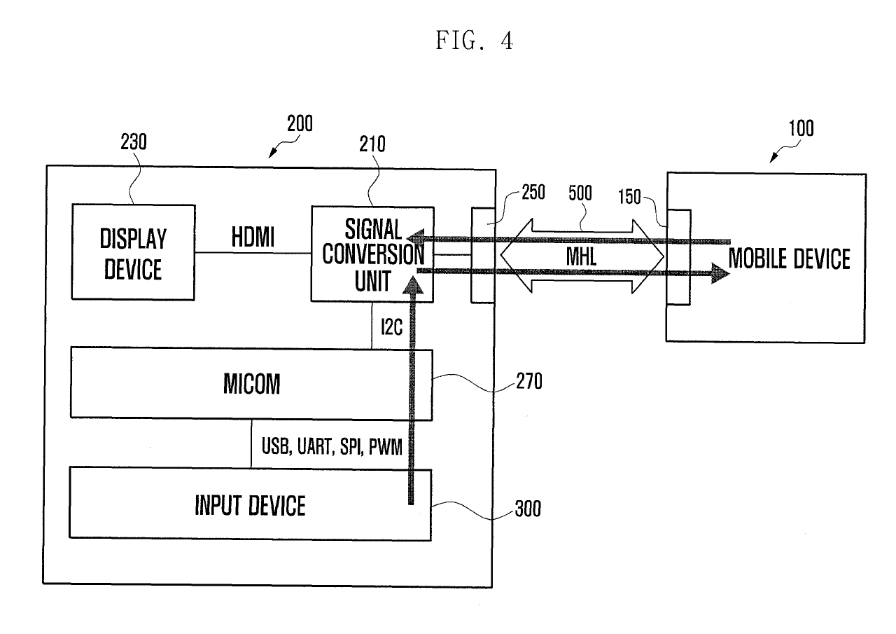

FIG. 4 illustrates an input signal transmission and reception relationship between an external device and a mobile device according to an exemplary embodiment of the present invention.

Referring to FIG. 4, it is assumed that the mobile device 100 and the external device 200 are connected through the interface 500 based on the MHL technology. Further, it is assumed that image data according to the user's selection is provided in the mobile device 100, and the image data is being outputted using the display device 230 of the external device 200. In such a situation, the user can control images, which are being outputted, (e.g., a volume control, and a replay speed control, etc.) and perform an input for performing a certain function (e.g., a menu calling function, and a data input function, etc.) using an input device 300 internally or externally connected to the external device 200.

Then the external device 200 can convert an input signal (particularly, an input signal corresponding to a communication method by a certain interface (e.g., a USB, UART, SPI and PWM)), which is generated according to user's input using the input device 300, into an I2C signal through the MICOM 270. That is, in order to convert an input signal generated by the input device 300 into an MHL signal which can be transmitted based on the MHL technology, the external device 200 can first convert the input signal into an I2C signal. Thereafter, the external device 200 can convert the I2C signal, which was converted through the MICOM 270, into a MHL-based MHL signal through the signal conversion unit 210.

Next, the external device 200 can transmit the MHL-based signal, which was converted through the signal conversion unit 210, to the mobile device 100 through the interface 500. In particular, the converted MHL-based signal can be transmitted through the CBUS line of the interface 500.

Further, the mobile device 100 can perform processing according to an input signal (i.e., the MHL-based input signal) of the external device 200 transmitted through the CBUS line of the interface 500, and transmit an image signal generated or converted according thereto to the external device 200. In particular, the image signal can be transmitted through the TMDS line of the interface 500.

If the image signal is transmitted through the TMDS line of the interface 500, the external device 200 converts the MHL-based image signal into a HDMI-based image signal through the signal conversion unit 210 as explained above, and is then outputted through the display device 230 using the converted HDMI-based image signal.

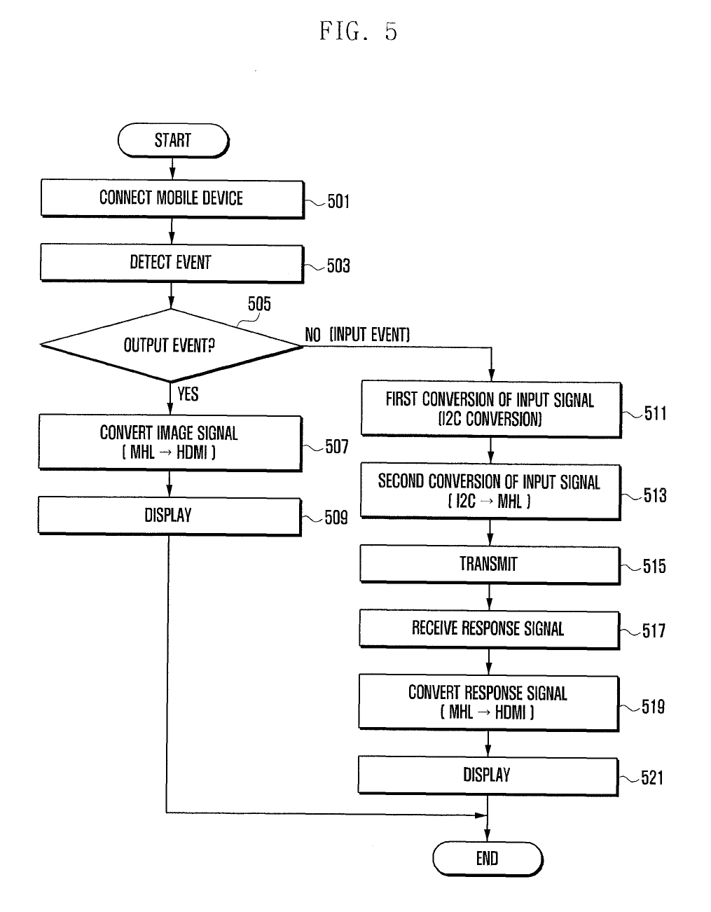

FIG. 5 is a flowchart illustrating a method of processing a signal according to a connection between an external device and a mobile device according to an exemplary embodiment of the present invention.

Referring to FIG. 5, the external device 200 is connected to the mobile device 100 through the MHL-based interface 500 in step 501. Further, the external device 200 can detect an event generated in the state in which the external device 200 is connected with the mobile device 100 in step 503. In the present exemplary embodiment, the event can be an event for outputting an image signal received from the mobile device 100 (hereinafter, referred to as an output event), or an event according to generation of an input signal from the input device 300 of the external device 200.

Next, if the event is detected, the external device 200 identifies the type of the event, and determines whether the event is an output event or an input event in step 505. For example, in the present exemplary embodiment, if an image signal is received through the TMDS line of the connector 250, the external device 200 recognizes the event as an output event, and if the image signal is generated using the input device 300, the event is recognized as an input event.

Thereafter, if the event is determined as an output event (Yes of step 505), the external device 200 converts an image signal transmitted from the mobile device 100 into a signal to be output using the display device 230 in step 507. In particular, if the image signal of the mobile device 100 is transmitted to the signal conversion unit 210 through the TMDS line of the connector 250, the external device 200 can convert the MHL-based signal (i.e., the image signal) into a HDMI signal using the signal conversion unit 210 for displaying the image corresponding to the image signal.

Next, the external device 200 can display an image corresponding to the converted HDMI signal using the display device 230 in step 509.

Further, if the event is recognized as an input event (No of step 505), the external device 200 performs a first conversion for the input signal transmitted from the input device 300 in step 511. For example, the external device 200 can convert an input signal, which is transmitted according to a communication method (e.g., a USB, UART, SPI and PWM, etc.) by which the input device 300 is connected, into an I2C signal. In the present exemplary embodiment, the I2C signal is a signal that is converted for communicating with the mobile device 100 or controlling the mobile device 100 in response to the input signal of the input device 300. That is, in the present exemplary embodiment, converting the input signal into an I2C signal corresponds to a configuration of converting an input signal of the input device 300 into an I2C signal within the external device 200 so that the input signal generated in the input device 300 can be recognized and controlled in the mobile device 100.

Thereafter, the external device 200 performs a second conversion for the input signal in step 513. For example, the external device 200 can convert the I2C signal into an MHL-based signal in order to transmit the converted I2C signal (i.e., the input signal) to the mobile device 100 through the interface 500 based on the MHL which is the protocol agreed with the mobile device 100.

Thereafter, the external device 200 transmits the signal (i.e., the input signal), which is converted based on the MHL, to the mobile device in step 515. In particular, the external device 200 can transmit the MHL-based signal (i.e., the input signal) through the CBUS line of the connector 250. At this time, the mobile device 100 can perform an internal processing according to the input signal transmitted based on the MHL. For example, the mobile device 100 can perform an internal processing such as function processing of an image being displayed through the display device 230, data input processing, and menu calling processing, etc. Further, the signal (e.g., a response signal responded to the input signal) according to the internal processing can be transmitted to the external device 200 through the MHL-based interface 500.

Thereafter, the external device 200 can receive a response signal to an input signal transmitted through the first conversion and the second conversion in step 517. In the present exemplary embodiment, the response signal can be an image signal which reflects the internal processing of the mobile device 100 in response to the input signal, or an image signal where a menu is added or a text is inputted in the image signal being displayed through the display device 230. Therefore, the response signal can be received through the TMDS line of the connector 250. That is, in FIG. 5, the response signal is a term that is used for convenience in explanation so as to be distinct from the term for the image signal used with respect to step 507.

Thereafter, the external device 200 converts a response signal transmitted from the mobile device 100 into a signal for output using the display device 230 in step 519. In particular, if the response signal of the mobile device 100 is transmitted to the signal conversion unit 210 through the TMDS line of the connector 250 through the MHL-based interface 500, the external device 200 can convert the MHL-based signal (i.e., the response signal) into the HDMI signal using the signal conversion unit 200 for the display of the image corresponding to the image signal.

Thereafter, the external device 200 can display the image corresponding to the converted HDMI signal based on the display device 230 in step 521.

As described above, according to an exemplary embodiment of the present invention, when a mobile device is connected to an external device 200 used as an accessory for the input and output of the mobile device, the interface for the input and output of the mobile device 100 can be a single interface. In particular, according to an exemplary embodiment of the present invention, the configuration of a separate interface for connection between the input device 300 and the mobile device 100 can be omitted by supporting the MHL-based interface and transmitting the input signal generated in the input device 300 using the CBUS line of the MHL-based interface. That is, in the present exemplary embodiment, it is possible to use the CBUS line in the MHL-based interface for transmitting an input signal of the external device 200 to the mobile device 100.

Meanwhile, a method for interfacing between an external device and a mobile device according to an exemplary embodiment of the present invention as described above may be implemented using executable program commands readable by at least one processor and recorded in a non-transitory computer readable recording medium.

In this case, the non-transitory computer readable recording medium may include program commands, a data file, and a data structure individually or a combination thereof In the meantime, the program commands recorded in the non-transitory computer readable recording medium may be specially designed or configured for the present invention or be known to a person having ordinary skill in a computer software field to be used.

The non-transitory computer readable recording medium may be a magnetic media such as hard disk, floppy disk, or magnetic tape, optical media such as Compact Disc Read Only Memory (CD-ROM) or Digital Versatile Disc (DVD), magneto-optical media such as floptical disk, and a hardware device such as Read Only Memory (ROM), Random Access Memory (RAM), flash memory storing and executing program commands. Further, the program commands may include a machine language code created by a complier and a high-level language code executable by at least one processor and/or a computer using an interpreter. The foregoing hardware device may be configured to be operated using at least one software module to perform an operation of the present invention, and vice versa.

As described above, according to a method and apparatus for interfacing between an external device and a mobile device according to an exemplary embodiment of the present invention, the external input and output function of a mobile device can be supported by a connection through a single connector between the external device and the mobile device. For example, according to an exemplary embodiment of the present invention, it is possible to output an image of a mobile device through an external device and perform control according to an input by an external device, simultaneously using a single connector. Therefore, it is possible to simplify an interface for connection between a mobile device and an external device.

Further, according to an exemplary embodiment of the present invention, a user does not need to connect two connectors for the external input and output of a mobile device. Further, according to an exemplary embodiment of the present invention, because a mobile device and an external device are connected by a single connector, a structural restriction can be addressed when designing devices. Further, connection between devices becomes convenient, and the possibility of malfunction of devices can be reduced when connecting the devices through the simplified connection. Further, when carrying a mobile device, portability is improved because the constitution of a connector for connecting to an external device is simplified.

Such an interface method and apparatus of exemplary embodiments of the present invention can be implemented in all types of mobile devices and various electronic device accessories connected thereto. Likewise, according to exemplary embodiments of the present invention, an optimal environment for interfacing between an external device and a mobile device can be implemented. Therefore, according to exemplary embodiments of the present invention, when using a function of a mobile device using an external device, user's convenience is improved, and the usability and competitiveness of a mobile device and accessories can be improved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for interfacing between a mobile device and an external device, the apparatus comprising:
a mobile device which includes image data for the external device, and which transmits to the external device an image signal corresponding to the image data according to a selection; and
an external device which displays the image data corresponding to the image signal received from the mobile device, which generates an input signal according to a user's input, and which transmits the generated input signal to the mobile device,
wherein the image signal of the mobile device and the input signal of the external device are transmitted and received through a single interface used for a connection between the mobile device and the external device.

2. The apparatus of claim 1, wherein the interface is based on a Mobile High definition Link (MHL) technology, and includes a first line for transmission and reception of the image signal, a second line for providing power the mobile device, and a third line for transmission and reception of the input signal of the external device.

3. The apparatus of claim 2, wherein the first line is a Transition Minimized Differential Signaling (TMDS) line, the second line is a Voltage Bus (VBUS) signal line, and the third line is a Communication Bus (CBUS) signal line.

4. The apparatus of claim 3, wherein the external device comprises:
a connector including the TMDS line, the VBUS signal line, and the CBUS signal line which supports the connection with the mobile device;
a display device which displays the image data corresponding to the image signal;
an input device which generates the input signal according to the user's input;
a Micro Computer (MICOM) which performs a first conversion for the input signal from the input device; and
a signal conversion unit which converts the image signal into a High Definition Multimedia Interface (HDMI) signal for displaying the image signal when the image signal is transmitted through the TMDS line, which performs a second conversion for an input signal transmitted after the first conversion from the MICOM, and which transmits the converted signal to the CBUS signal line.

5. The apparatus of claim 4, wherein the first conversion converts the input signal transmitted according to a communication method, by which the input device is connected, into an Inter-Integrated Circuit (IC) (I2C) signal, and the second conversion converts the converted I2C signal into an MHL-based signal for transmission through the interface based on the MHL technology.

6. The apparatus of claim 4, wherein the mobile device transmits a response signal to the external device after internal processing of the input signal, and the external device displays the image data according to the response signal using the display device.

7. A method of interfacing between a mobile device and an external device, the method comprising:
detecting an event generated in a state where the external device is connected to the mobile device through a single interface based on a Mobile High definition Link (MHL) technology;
if the detected event is an output event of the external device, performing a first display process by converting an image signal transmitted from the mobile device and displaying the converted image signal using a display device;
if the detected event is an input event of the external device, converting an input signal generated by an input device and transmitting the converted input signal to the mobile device through the single interface; and
if a response signal based on the input signal is received from the mobile device, performing a second display process by converting the response signal from the mobile device and displaying the converted response signal using the display device.

8. The method of claim 7, wherein the image signal transmitted from the mobile device is a MHL based signal.

9. The method of claim 7, further comprising:
if the external device detects the event, identifying the type of the event,
wherein the event is recognized as the output event if the event is the transmission of the image signal from the mobile device through a Transition Minimized Differential Signaling (TMDS) line of the single interface, and the event is recognized as the input event if the event is the input signal generated by the input device.

10. The method of claim 7, wherein the performing of the first display process comprises:
if the image signal transmitted from the mobile display is transmitted through a Transition Minimized Differential Signaling (TMDS) line of the single interface, converting the image signal into a High Definition Multimedia Interface (HDMI) signal for displaying image data corresponding to the image signal; and
displaying the image data corresponding to the converted HDMI signal using the display device.

11. The method of claim 7, wherein converting of the input signal generated by the input device comprises:
performing a first conversion for the input signal; and
performing a second conversion for the input signal converted according to the first conversion.

12. The method of claim 11, wherein the performing of the first conversion comprises converting the input signal transmitted according to a communication method, by which the input device is connected, into an Inter-Integrated Circuit (IC) (I2C) signal, and
wherein the second conversion comprises converting the converted I2C signal into a MHL-based signal in order to transmit the input signal to the mobile device through the single interface.

13. The method of claim 11, wherein the input signal converted according to the first conversion and the second conversion is transmitted through the Communication Bus (CBUS) signal line of the single interface.

14. The method of claim 13, further comprising:
performing, by the mobile device, internal processing according to the input signal received from the external device, and transmitting a response signal according to the internal processing to the external device through a Transition Minimized Differential Signaling (TMDS) line of the single interface; and
if the response signal is transmitted through the TMDS line of the single interface, converting the response signal into a High Definition Multimedia Interface (HDMI) signal, and displaying image data corresponding to the converted HDMI signal using the display device.

15. The method of claim 14, wherein the response signal transmitted through the TMDS line of the single interface is a MHL based signal.

16. The method of claim 14, wherein the response signal is one of an image signal which reflects internal processing of the mobile device in response to the input signal, and an image signal where a menu is added or a text is inputted.
